(19) United States
(12) Patent Application Publication
(10) Pub. No.: US 2012/0228385 A1
(43) Pub. Date: Sep. 13, 2012

(54) Method and apparatus for improved exercise machine

(76) Inventors: Bryan DeLuca, Dallas, TX (US); Ryan E. Overturf, Richardson, TX (US); William C. Branham, Dallas, TX (US)

(21) Appl. No.: 13/290,216

(22) Filed: Nov. 7, 2011

Related U.S. Application Data
(60) Provisional application No. 61/450,514, filed on Mar. 8, 2011.

(51) Int. Cl. G06K 19/00; G06F 17/30; G09G 5/00; G06K 19/06

(52) U.S. Cl. 235/487; 235/494; 235/375; 345/156

(57) ABSTRACT

A method for linking an exercise video to exercise equipment based on a machine readable code and an apparatus for processing exercise data. In one embodiment, a method is provided comprising posting an exercise video online wherein the video has a unique URL, creating a machine readable code for the unique URL, attaching the machine readable code to the exercise equipment, using a device having an application to decode the machine readable code, and displaying the exercise video on the device to a user. In one embodiment, an electronic device is provided comprising a display device, a memory storing a plurality of exercise data, an input element, and circuitry in communication with the display device, memory and input element.

### CROSS-REFERENCE TO RELATED APPLICATION

This application claims the benefit of U.S. Provisional Application No. 61/450,514, filed Mar. 8, 2011, which is incorporated by reference herein.

### TECHNICAL FIELD OF THE INVENTION

The present invention relates to an improved exercise machine. Specifically, the machine is equipped with a QR Code or other machine readable code that provides a user held device to scan the code and obtain a link to an online video or image(s) that provides instruction on how the exercise machine is designed to be used.

### BACKGROUND OF THE INVENTION

Exercise equipment has become increasingly complex over time. Dumbbells and a jump rope were simple devices that needed very little explanation. Over time, machines became more specialized and adjustable. For example, the original Nautilus brand machines incorporated a weight stack and a pin that allowed the user to adjust the amount of weight being used for resistance. Also, the seat location and other elements were adjustable. More importantly, as these machines became more specialized, a single machine might be useful in exercising a single muscle group.

As the machines became more specialized, the users also became more sophisticated in their goals. Men might want to develop greater muscle mass in their chest and shoulders, while women might seek a more slender and toned look in the hips and thighs. To achieve these goals, many users employ personal trainers. A trainer is an expert in the proper positioning of the body and the proper range of motion for a particular exercise. A trainer will work with a client to ensure that the client performed the exercise on a particular piece of fitness equipment properly. For example, on a rowing machine, the trainer might help a client sit with the proper posture and limit his motion to achieve the optimal results and also to avoid unneeded strain and injury during the exercise.

Trainers are expensive—a luxury that not all users can afford. Trainers' rates can vary from $50/session to over $500/session. For this reason, many people will use exercise equipment without the aid of a trainer. Equipment manufacturers attempt to assist the user by putting simple illustrations on each machine. FIG. 1 is an illustration of a prior art machine made by Cybex, a leading manufacturer of specialized exercise equipment. An exemplary machine 10 is shown having a weight stack 12 and a seat 14. The weight stack is partially shielded from the user by a front panel 16. The user engages the machine by selecting an appropriate weight using a pin 20. He then presses on the foot plate 30 to raise the stack 12. The user is provided illustrations 24, 26, and 28 which are located on front panel 16. These illustrations provide only a generic idea on how to use the machine. For instance, they illustrate which muscle groups are involved, and perhaps two variations on how the exercise is performed. In this example, the machine is designed to exercise the user's quadriceps. The user is provided some simple visual guidance on how to press the foot plate 30 forward.

However, while these illustrations provide some assistance, they cannot provide the specialized assistance that a personal trainer can. For instance, the illustrations do not provide any verbal guidance. The user receives no instruction to keep his back straight, to exhale during the pulling motion, to maintain smooth movements, to keep his elbows in, and the like. A video provides better instructional value than a simple, static picture that merely shows the start and endpoints of an exercise motion.

### SUMMARY OF THE INVENTION

The present invention is defined by the claims and nothing in this section should be taken as a limitation on those claims.

The present invention provides a method and apparatus for assisting a user in the gym without the benefit of a warm-bodied personal trainer. The invention provides a method for providing instructional videos to a user for various exercise equipment, including weighted machines such as the Nautilus branded workout machines. A user approaches a specific machine which has an attached machine readable code. The user employs a device that can decode the machine readable code, such as a smart-phone. The device then displays an example video associated with the specific machine that demonstrates proper technique for using the device. The video may comprise a certified personal trainer performing an exercise on the machine, complete with audio tips regarding common mistakes or important aspects of the exercise. The user will emulate the personal trainer on the video and be more able to perform the exercise correctly.

The present invention also provides an apparatus for assisting the user in the gym to better perform exercises associated with exercise equipment. This apparatus could be a hand-held device, such as a smart phone, with a memory unit, an input element, a display device, and circuitry capable of displaying data stored in the memory on the display device for the benefit of the user. The data stored in the memory comprises data related to a plurality of exercises. For each exercise, the memory may comprise exercise information such as a video of the exercise being performed, a number of sets and repetitions, an amount of resistance, an amount of time to complete the exercise, the user's performance history in the exercise, and the name of the next exercise in a series of exercises.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an illustration of a prior art exercise machine.

FIG. 2 is an enlarged illustration of the front panel of the exercise machine of FIG. 1 with the addition of a machine readable code.

FIG. 3 is a flow chart of an exemplary method for improving the exercise of a user.

FIG. 4 is a block diagram of an electronic device of an embodiment of the present invention.

FIG. 5 is an illustration of an electronic device of an embodiment of the present invention.

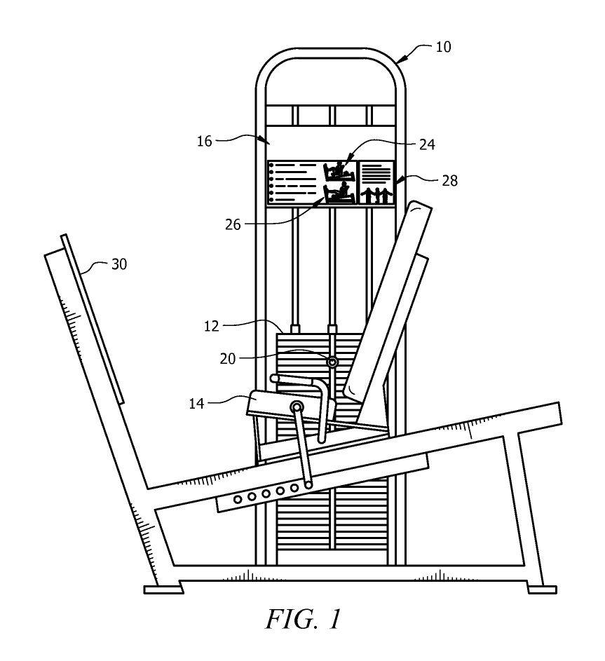

### DETAILED DESCRIPTION OF THE DRAWINGS

Before describing in detail exemplary embodiments that are in accordance with the present invention, it is noted that the embodiments reside primarily in combinations of apparatus components and processing steps related to implementing a system and method for linking an exercise to video to exercise equipment and an apparatus for processing and displaying exercise data. Accordingly, the system, method, and apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

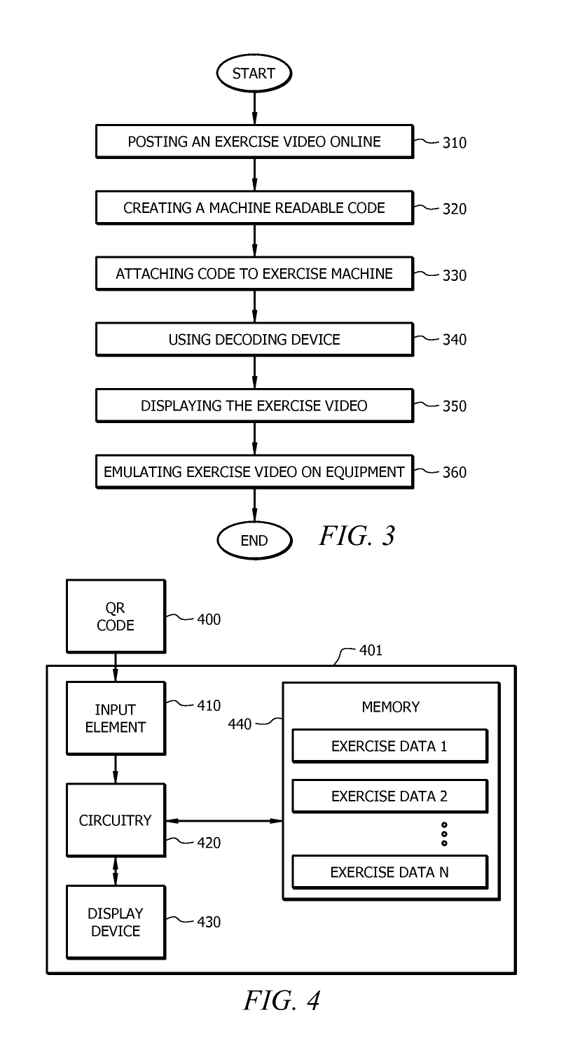

Several embodiments of Applicant's invention will now be described with reference to FIG. 3, which depicts a process diagram of one embodiment of the current invention. Although this embodiment shall be described sequentially, nothing in this disclosure should be taken to limit the invention to a set sequence.

In one embodiment, the first step is posting an exercise video online (STEP 310) wherein the video has a unique Universal Resource Locator (“URL”). As used herein, “online” refers to either a wide area network, such as the World Wide Web (“WWW”) or a local area network, such as a wireless intra-network accessible within a gym. The video has a unique URL to identify the video online by specifying where the video is available and the mechanism for retrieving the video. The video may comprise both video and audio data of a certified personal trainer performing an exercise on exercise equipment. The exercise equipment may be one of many prior art exercise machines including, but not limited to, a latissimus dorsi pull-down machine, shoulder press machine, dip bars, cable machine, leg press machine, hamstring curl machine, calf raise machine, incline/decline/parallel bench press machine, rowing machine, low row machine, and assisted pull-up machine. The personal trainer demonstrates proper form and technique and may provide auditory tips beyond those tips displayed on the front cover 16. Some of these tips may include common mistakes that novices make, problems that experienced users encounter, as well as the number of sets to perform and the number of repetitions per set. The personal trainer may also recommend the amount of resistance for the user to select if the machine, such as a shoulder press machine, has a selectable resistance.

In one embodiment, the next step is creating a machine readable code (STEP 320) for the unique URL of the exercise video. This machine readable code may be a UPC bar code, a Data Matrix code, MaxiCode, or a QR code. One skilled in the art would understand the methods of producing machine readable codes. One embodiment of the present invention comprises a machine readable code that is a QR code.

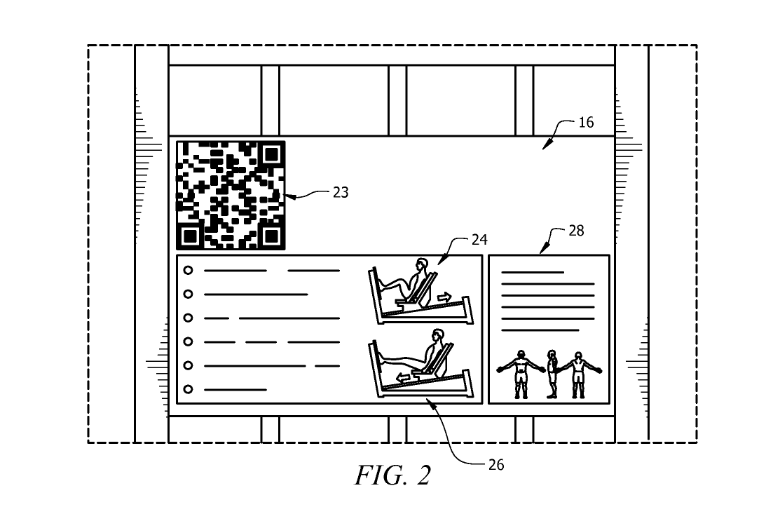

In one embodiment, the next step is attaching the machine readable code to the exercise equipment (STEP 330). As shown in FIG. 2, machine readable code 23 may be placed on the front panel 16 near the static instructional pictures 24, 26, 28 commonly included on a prior art exercise machine. This placement allows the user to easily see the machine readable code.

In one embodiment, the next step is using a device having an application to decode the attached machine readable code (STEP 340). In one embodiment, the device is a smart-phone. As used herein, a “smart-phone” is a mobile phone that offers more advanced computing ability, including the ability to run applications, and more connectivity than a contemporary lower-end mobile phone. Examples of smart-phones include the Apple Inc. iPhone, mobile phones running the Google Android Operating System, and various Blackberry and Palm phones. The device decodes the machine readable code by storing an image of the machine readable code and processing it through an appropriate application. The image may be captured and stored through the use of a digital camera or a scanner. One skilled in the art would understand the methods of using applications to store images and decode machine readable codes.

In one embodiment, the next step is displaying the exercise video on the device to a user (STEP 350). The device uses the URL from the using step, discussed above, to access the exercise video from the online network. In one embodiment, the next step is downloading the exercise video to the device before displaying the exercise video. This downloading step provides the user the ability to watch the video later in time, regardless of the user's presence within the gym near the machine readable code. One skilled in the art would understand the methods of downloading videos to devices such as smart-phones. The device may have a liquid crystal display (“LCD”) to display the visual component and speakers to provide the auditory component of the exercise video.

In one embodiment, the next step is emulating the exercise video by the user on the exercise equipment (STEP 360). Once the user watches the exercise video, the user is better prepared to undertake the exercise on the exercise equipment. The user can follow the instructions of the personal trainer provided through the exercise video and avoid the common pitfalls associated with many pieces of exercise equipment found in gyms.

Another embodiment of the present invention is an apparatus for processing exercise data. FIG. 4 is a block diagram of an apparatus of an embodiment. The apparatus is an electronic device. As used herein, an “electronic device” refers to any device that uses electricity for some or all of its functionality. The electronic device 401 can be a wired or wireless device, and in some embodiments, takes the form of a portable handheld device, such as a smart-phone. As shown in FIG. 4, the electronic device 401 of this embodiment comprises a memory 440 storing a plurality of exercise data for an exercise (Exercise Data 1, Exercise Data 2, . . . Exercise Data N) that, when accessed, provides the electronic device 401 with certain functionality. The memory 440 can take any suitable form, such as, but not limited to, solid-state, magnetic, optical, or other types of memory.

The electronic device 401 also comprises a display device 430 (e.g., a LCD) for providing the display (e.g., a graphical form or chart of the exercise data) and an input element 410 for accepting an input from a user. In one embodiment, the input element 410 comprises an image. In one embodiment, the input element 410 image is a QR code 400. In another embodiment, the input element 410 comprises a camera. The input element 410 is not limited to the above; the input element 410 may comprise a keyboard, a keypad, wheels, buttons, switches, or a touch-screen. When in the form of a touch-screen, the display device 430 can also accept user input when a user touches a selection choice displayed on the display device 430.

The electronic device 401 also comprises circuitry 420 in communication with the various components described above. As used herein, “in communication with” means in direct communication with or in indirect communication with through one or more components, which may be named. “Circuitry” can include one or more components and can be a pure hardware implementation and/or a combined hardware/software/firmware implementation. Accordingly, “circuitry” can take the form of one or more of a microprocessor or processor that runs applications and other computer-readable program code stored in the memory 440 in the electronic device 401. In one embodiment, the circuitry 420 is operative to select one of the plurality of exercise data based on the input element 410.

In one embodiment, the exercise data comprise a video of the exercise. This video could be a video of a personal trainer performing an exercise on exercise equipment, such as the exercise video discussed above. In another embodiment, the exercise data comprise sets and repetitions to be performed by the user of the device. In another embodiment, the exercise data comprise a resistance to be used in the exercise. In another embodiment, the exercise data comprise a time to perform the exercise. In another embodiment, the exercise data comprise a plurality of exercises to be performed in a predetermined order. Many exercise routines consist of a series of exercises, to be performed in a particular order. Performing exercises in a particular order can maximize results by allowing a first set of muscles to recuperate during an exercise that targets a second set of muscles. In another embodiment, the exercise data comprise a history of sets, repetitions, and resistances performed by the user of the apparatus.

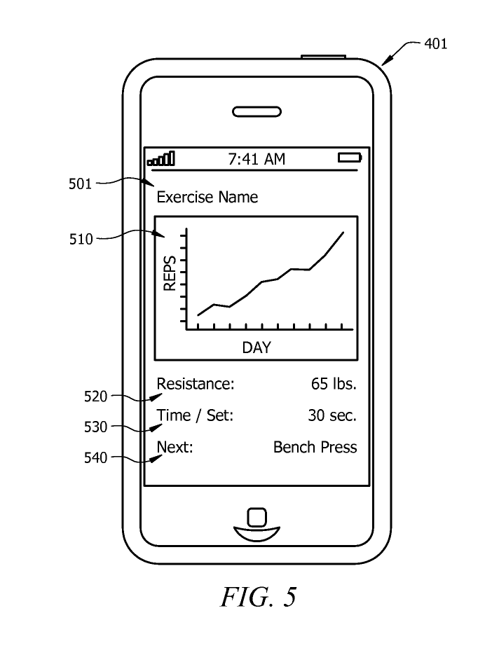

The display device 430 of the electronic device 401 can display the exercise data in multiple ways. One embodiment displays the history of sets, repetitions, and resistances performed by the user in a graph. FIG. 5 provides an exemplary display of one embodiment of the electronic device 401. The display may contain the exercise name 501, the user's performance history of the exercise 510, the amount of resistance used in the exercise 520, the time to perform the exercise 530, and the next exercise for the user to perform in a series of exercises 540.

In the description above and throughout, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of the embodiments is not intended to limit the scope of the claims appended hereto. Further, in the methods disclosed herein, various steps are disclosed illustrating some of the functions of the present invention. One will appreciate that these steps are merely exemplary and are not meant to be limiting in any way. Other steps and functions may be contemplated without departing from this disclosure or the scope of the present invention.

We claim:

1. A method of linking an exercise video to an exercise equipment comprising the steps of:
a. posting an exercise video online wherein the video has a unique URL;
b. creating a machine readable code for the unique URL; and
c. attaching the machine readable code to the exercise machine.

2. The method of claim 1, wherein the method further comprises the step of using a device having an application to decode the attached machine readable code.

3. The method of claim 1, wherein the method further comprises the step of displaying the exercise video on the device to a user.

4. The method of claim 1, wherein the method further comprises the step of emulating the exercise video by the user on the exercise equipment.

5. The method of claim 1, wherein the machine readable code is a QR code.

6. The method of claim 1, wherein the device is a smart-phone.

7. The method of claim 1, wherein the video comprises visual and audio data.

8. The method of claim 1, wherein the method further comprises the step of downloading the exercise video to the device before displaying the exercise video.

9. An apparatus for processing exercise data, the apparatus comprising:
a. a memory, the memory storing at least one exercise data for an exercise;
b. an input element;
c. a display device; and
d. circuitry in communication with the display device, the input element, and the memory wherein the circuitry is operative to select at least one of said at least one exercise data based on the input element and display the said at least one exercise data to a user of the apparatus.

10. The apparatus of claim 9, wherein the input element comprises a camera.

11. The apparatus of claim 9, wherein the at least one exercise data comprises a video of the exercise.

12. The apparatus of claim 9, wherein the at least one exercise data comprises sets and repetitions to be performed by the user.

13. The apparatus of claim 9, wherein the at least one exercise data comprises a resistance to be used in the exercise.

14. The apparatus of claim 9, wherein the at least one exercise data comprises a time to perform the exercise.

15. The apparatus of claim 9, wherein the at least one exercise data comprises a plurality of exercises to be performed in a predetermined order.

16. The apparatus of claim 9 wherein the at least one exercise data comprises a history of sets, repetitions, and resistances performed by the user.

17. The apparatus of claim 16 wherein the apparatus displays the history of sets, repetitions, and resistances performed by the user in a graph.

18. The apparatus of claim 9, wherein the input element comprises a camera.

19. The apparatus of claim 9, wherein the input element comprises an image.

20. A method for improving an exercise machine comprising the step of displaying a machine readable code on an exercise machine, said machine readable code identifying an exercise video.
